(19) United States
(12) Patent Application Publication
(10) Pub. No.: US 2012/0226601 A1
(43) Pub. Date: Sep. 6, 2012

(54) SYSTEM AND METHOD OF INDIVIDUAL FINANCING WITH REPAYMENT ENFORCEMENT

(75) Inventors: David Earl COLE, Temecula, CA (US); Steven N. THOMAS, Spring, TX (US)

(73) Assignee: U-FI LLC, Spring, TX (US)

(21) Appl. No.: 13/038,787

(22) Filed: Mar. 2, 2011

(51) Int. Cl. G06Q 40/00

(52) U.S. Cl. 705/39; 705/35

(57) ABSTRACT

A system and method to allow individual financing of a purchase or lease of an apparatus with enhanced repayment is described. The system provides an interface and services for individual financing. Repayment is enhanced through the coupling of a payment protection system with the apparatus. A tamper protection system is also coupled with the apparatus to prevent tampering with the payment protection system.

### FIELD OF THE INVENTION

The present invention relates generally to ensuring payments when financing the purchase of an item or leasing an item.

### BACKGROUND OF THE INVENTION

When any item is financed, the loan-provider or leaser seeks timely and complete payment according to the financing agreement. When payments are missed, some financed items, like a home, can be located and steps can be taken to recover missed payments or the items themselves. However, many other financed items, like jewelry or a car, for example, are more difficult to locate if a loan-recipient chooses to miss payments and abscond with the items.

Accordingly, it is desirable to provide a system that encourages prompt payment and, in the absence of payment, ensures termination of use and easy retrieval of the financed item.

### SUMMARY OF THE INVENTION

In accordance with one embodiment of the present invention, a system of facilitating financing is described. The system comprises a server. The server is configured to interface with a first user and a second user, the first user financing a transfer of an apparatus to the second user. The server comprises a service module to provide services requested by the first user or the second user; a payment verification module to receive a first payment from the second user; a payment issuance module to issue a second payment; and a code generator module configured to generate and transmit a code based on the received first payment. The system further comprises a payment protection unit coupled with the apparatus, the payment protection unit comprising a disable unit configured to disable an operation of the apparatus at a predetermined time; and a stop unit configured to stop the disable by the disable unit when the code is received by the payment protection unit.

According to another embodiment of the present invention, a system of facilitating financing is described. The system comprises a web interface. The web interface, resulting from processing of software by a processor, is presented to a first user who owns an apparatus and to a second user. The web interface provides a registration portion to register the first user and the second user and a transfer portion to negotiate a transfer of the apparatus from the first user to the second user. The system also comprises a payment protection unit coupled with the apparatus, the payment protection unit comprising a disable unit configured to disable an operation of the apparatus at a predetermined time; and a stop unit configured to stop the disable by the disable unit when a code is received by the payment protection unit.

According to another embodiment of the present invention, a method of facilitating financing is described. The method comprises the steps of providing an interface to a first user and a second user to receive services and to arrange a transfer of an apparatus from the first user to the second user; verifying a first payment from the second user; providing a code for entry in a payment protection unit coupled with the apparatus to prevent the payment protection unit from disabling the apparatus, based on verification of the first payment; and issuing a second payment based on the first payment.

There has thus been outlined, rather broadly, certain embodiments of the invention in order that the detailed description herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of a server according to an embodiment of the invention.

FIG. 2 is a block diagram of a payment protection unit according to an embodiment of the invention.

FIG. 3 is a block diagram of a tamper protection unit according to an embodiment of the invention.

FIG. 4 is a flowchart illustrating steps that may be followed in accordance with an embodiment of the method of practicing the invention.

FIG. 5 is a flowchart illustrating additional steps that may be followed according to the embodiment of the method illustrated at FIG. 4.

### DETAILED DESCRIPTION

The financing of portable items can be risky, because repossession of a financed item for which payments have not been made can be made more challenging when the loan-recipient or lessee is able to abscond with or hide the item.

This risk has discouraged businesses and, generally speaking, precluded individuals from financing higher-ticket items, such as cars, farm equipment, and construction equipment, in the past. However, if an individual could be more certain of timely payments, there are several advantages to individual financing, such as a higher sale price.

For example, the private sale of a car typically yields a higher price than a trade-in or sale to a wholesaler. However, a private sale can be more difficult for an individual seller who, unlike a used-car dealer, for example, is unprepared to finance the sale.

Among the tools that dealerships have had to allow financing, is the ability to evaluate risk for a given loan-recipient or lessee based on credit score and other information.

Thus, one embodiment of the present invention is to provide a system and method to facilitate individual financing. As detailed below, non-limiting embodiments and aspects of the inventive system and method include an interface with both the loan-provider or leaser and, often times, seller and the loan-recipient and buyer, a provision of information services to the loan-provider or leaser, and a payment enforcement system to encourage payments by the loan-recipient or lessee.

For a loan-provider who is the seller of an item, such as an automobile, the inventive system and method provide advantages that include maximizing the sale price while reducing the financial risk of providing financing for the item. For the loan-recipient who is the purchaser of an item, such as an automobile, the inventive system and method advantageously provide a single facility for both the selection and financing of the item.

Referring now to the drawings, like reference numerals designate identical or corresponding parts throughout the drawings.

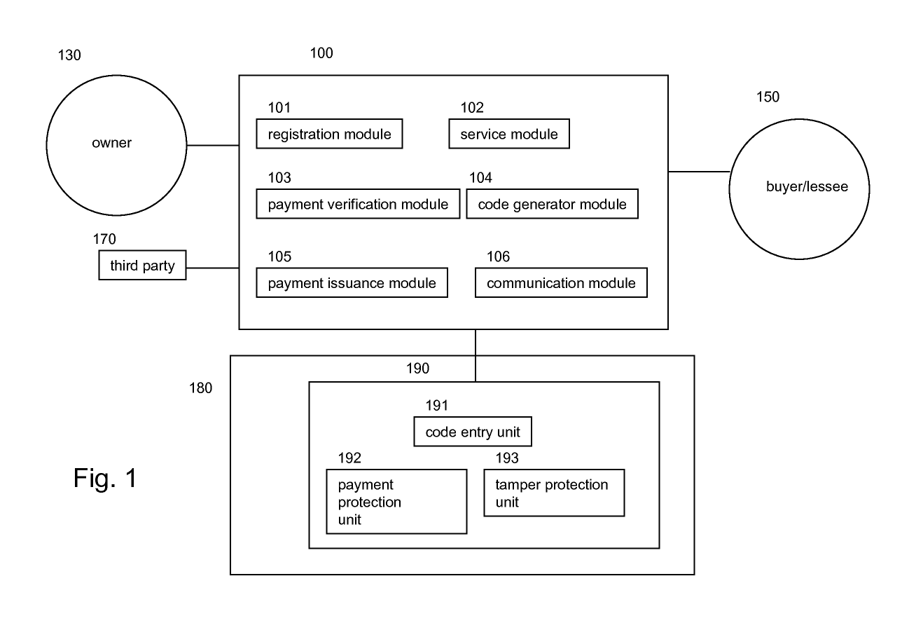

FIG. 1 is a block diagram of a server 100 according to a non-limiting embodiment of the present invention. The server 100 is, for example, a computer with various software modules stored in a memory and implemented by a processor and hardware components employed for, for example, communication over a network.

The software implementation of the various modules would include at least a memory (e.g. ROM, EPROM, EEPROM, flash memory, static memory, DRAM, SDRAM, and their equivalents) to store program instructions and at least one processor/microprocessor to execute the instructions. In addition, the modules would include algorithms to carry out the specified functionality.

The server 100 is shown as a single computer for simplicity. However, functionality of the various modules of the server 100 may be implemented by multiple computers which may communicate with each other over a network, such as the internet. In addition, each software module may be stored in one or more memory devices. Individually or as a combination of devices, the server 100 provides functionality to allow individual financing of the purchase or lease of an apparatus 180.

The server 100 comprises a registration module 101, a service module 102, a payment verification module 103, a code generator module 104, a payment issuance module 105, and a communication module 106.

The server 100 interfaces with an owner 130 who wishes to sell or lease an apparatus 180. The interface with the owner 130 may be through a website, over a landline or cellular telephone, or by another means of communication. The server 100 also interfaces with a buyer/lessee 150 who wishes to buy or lease the apparatus 180. The interface with the buyer/lessee 150 may be through a website, over a landline or cellular telephone, a bank machine that allows the buyer/lessee 150 to make a payment, or by another means of communication.

The registration module 101 performs processing to provide a membership in the server 100 system to the owner 130 and the buyer/lessee 150. The registration process may include establishing a username and password to access the membership services of the server 100 system. The membership registration process may also include a payment processed through the server 100.

The service module 102 provides information services. For example, each member buyer/lessee 150 may be required to purchase a credit verification and risk evaluation report. This report could then be used to provide loan services to an owner 130 who is considering a sale or lease to the buyer/lessee 150 and, thereby, eliminate the need for the owner 130 to separately pre-qualify the buyer/lessee 150.

Many other services could also be offered and provided by the service module 102. One example is an insurance verification service to verify that the buyer/lessee 150 is insured in accordance with the terms of the sale or lease and with the applicable state laws. Another example is a skip guarantee service to insure cash back to the owner 130 if the buyer/lessee 150 “skips” off with the apparatus 180. Another example is a remarketing service in case the buyer/lessee 150 does not complete the full term of the original payment agreement. Another example is escrow services to ensure the safe transfer of the title of the apparatus 180 in the case of a sale. Another example is a referral service to refer the owner 130 and/or the buyer/lessee 150 to additional sources of information. Referrals could be provided, for example, to a website that lists resale values of the type of apparatus the buyer/lessee 150 is considering. Referrals may also be provided for insurance and mechanical services.

Through the interface provided by the server 100, the owner 130 and buyer/lessee 150 negotiate the transfer of the apparatus 180 from the owner 130. An exemplary interface is a web page that details information about the apparatus 180 to be transferred. For example, the apparatus 180 may be a vehicle being leased by the lessee 150, and the interface may be a web page that details the make, model, year, mileage, and condition of the vehicle and provides photographs, as well. Each of the various ways that the transfer may occur is discussed as a non-limiting embodiment.

In a non-limiting embodiment, the owner 130 finances the purchase of the apparatus 180 by the buyer 150. The finance agreement negotiated through the server 100 interface sets out a payment schedule and the pertinent terms associated with late payments by the buyer 150, including disabling and repossession of the apparatus 180, the service fee paid by the owner 130 to the server 100 system, and installation of a payment protection system 190 coupled with the apparatus 180.

The apparatus 180 may be any one of a variety of types of equipment. For example, the apparatus 180 may be a vehicle such as a car, motorcycle, or mobile home. The apparatus 180 may also be, for example, farm equipment such a tractor, construction equipment such as a crane or cement truck. The apparatus 180 may be marine equipment such as a boat or other watercraft. The apparatus 180 may be office equipment such as, for example, a printer. The apparatus 180 may also be building equipment such as, for example, an air conditioning unit or backup generator.

In one embodiment, the payment protection system 190 may include a commercially available system, such as the loan repay enforcement system described by U.S. Pat. No. 6,195,648, with a code entry unit 191 and a payment protection unit 192. Additionally, the payment protection system 190 may include a tamper protection unit 193.

While the payment protection system 190 is shown at FIG. 1 as a single, integrated system, the code entry unit 191 and the various components of the payment protection unit 192 and the tamper protection unit 193 may be positioned at different places within or outside of the apparatus 180.

For example, the code entry unit 191 may be on or under the dashboard of the apparatus 180 that is a vehicle and be conveniently accessible to a buyer 150. Alternatively, the code entry unit 191 may not be positioned in a location that is physically convenient for the buyer 150 to access but may receive a code remotely such that physical accessibility is not an issue. The code may be transmitted remotely by the server 100 system or the buyer 150 through a cellular phone or other transmitting device. A smart card or key fob may be used to transmit the code in another embodiment. Exemplary codes include, but are not limited to numeric, alpha-numeric, and symbol-based codes.

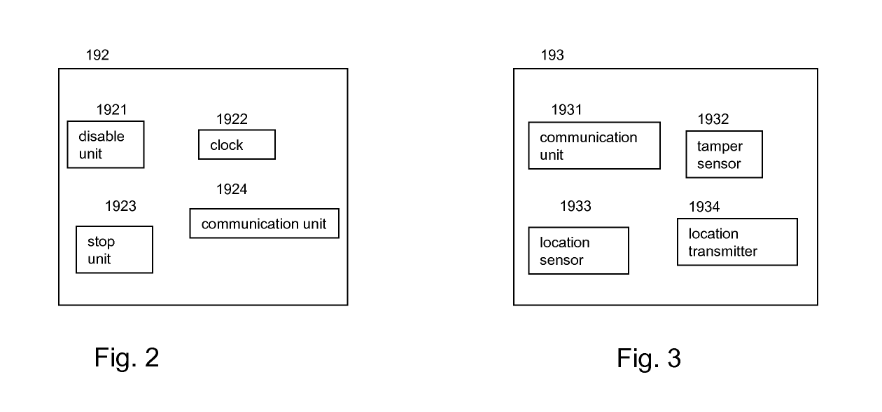

FIG. 2 is a block diagram of an embodiment of the payment protection unit 192 of the payment protection system 190. The payment protection unit 192 comprises a disable unit 1921, a clock 1922, a stop unit 1923, and a communication unit 1924 for communication with the tamper protection unit 193.

The disable unit 1921 of the payment protection unit 192 disables the start and operation of the apparatus 180 within which it is integrated, based on a predetermined time and a time indicated by the clock 1922 (i.e., when the clock 1922 indicates that the time is the predetermined time). The predetermined time may be programmed to be set on a rolling basis. That is, the predetermined time may be set as a certain day of a month and then, on a rolling basis, as a certain day, the same date or the same number of days in interval, for example, of the next month, the month after that, etc. In another embodiment, the predetermined time may be set for a longer period such as six months or a year, for example.

The pre-programmed disable function of the payment protection unit 192 may be terminated by the stop unit 1923 for the current predetermined time period by entry of a correct code at the code entry unit 191.

For example, the payment protection unit 192 may be programmed to disable start and operation of the apparatus 180 on the 3^{rd} of each month. By obtaining and entering a correct code in the code entry unit 191 on or before the 3^{rd} of the month, the pre-programmed disable function of the disable unit 1921, set for the current month, can be stopped or reset by the stop unit 1923. The next month, the procedure would repeat. That is, by entering a correct code in the code entry unit 191 by the 3^{rd} of the next month, the pre-programmed disable function of the disable unit 1921 set for the 3^{rd} of that month could be stopped by the stop unit 1923.

FIG. 3 is a block diagram of an embodiment of a tamper protection unit 193 coupled with the payment protection unit 192.

The tamper protection unit 193 comprises a communication unit 1931 for communication with the payment protection unit 192, a tamper sensor 1932, a location sensor 1933, and a location transmitter 1934.

The communication unit 1924 of the payment protection unit 192 sends an intermittent signal (which may be periodic) to the communication unit 1931 of the tamper protection unit 193. Tampering with the payment protection unit 192, which is connected to the starter, by rewiring to disconnect the payment protection unit 192 from the starter will also disconnect the communication unit 1931 of the tamper protection unit 193. Thus, if a signal is not received by the communication unit 1931 of the tamper protection unit 193 within a predetermined period of time at the predetermined frequency from the communication unit 1924 of the payment protection unit 192, the tamper sensor 1932 determines that the payment protection unit 192 has been tampered with.

When the tamper sensor 1932, which may represent the overall processor and controller of the tamper protection unit 193, determines that the payment protection unit 192 has been tampered with, the location sensor 1933 is directed to determine the current location of the apparatus 180 within which the payment protection unit 192 and the tamper protection unit 193 are both integrated. Once the location sensor 1933 determines the current location of the apparatus 180, the location transmitter 1934 transmits the location of the apparatus 180 to the server 100 system to allow retrieval of the apparatus 180. The location sensor 1933 may be, for example, a Global Positioning System (GPS) receiver.

In conjunction with and, sequentially before or after the location sensor 1933 is directed to determine the current location of the apparatus 180, the tamper sensor 1932 disables start and operation of the apparatus 180 in a similar way that the disable unit 1921 of the payment protection unit 192 would disable operation.

The coupling of the payment protection unit 192 with the apparatus 180 encourages the buyer or lessee 150 of the apparatus 180 to make timely payments in order to obtain the correct code for entry into the code entry unit 191 and to, thereby, stop the otherwise automatic disabling of the functionality of the apparatus 180.

The additional coupling of the tamper protection unit 193 with the payment protection unit 192 encourages the buyer or lessee 150 to avoid disabling of the apparatus 180 through timely payments rather than through tampering with the payment protection unit 192.

The following continues the description of the non-limiting embodiment relating to the sale of the apparatus 180, with financing by the owner 130, to the buyer 150. When a timely payment is received from the buyer 150, the payment verification module 103 verifies the timing and amount of the payment. The payment may be made, for example, through a pre-paid credit or debit card purchased by the buyer 150 through the server 100 system. Payment may be made to a specified account and a notification of payment, rather than the payment itself, may be received by the server 100 system.

When the payment verification module 103 verifies that the correct amount of payment is received by the correct date from the buyer 150, the code generator module 104 issues a code to the buyer 150. The code issued by the code generator module 104 is the code to be entered in the code entry unit 191 of the payment protection system 190. Additionally, when the payment is verified by the payment verification module 103, a payment equivalent to the payment made by the buyer 150 minus the service fee to the server 100 system is computed by the payment issuance module 105 for issuance to the owner 130.

The communication module 106 of the server communicates the code issued by the code generator module 104 to the buyer 150 via a text message, an email, a voicemail, a message available when the buyer 150 dials into a predetermined phone number such as a toll-free number, or any other convenient means of communication. The communication module 106 may instead communicate the code directly to the payment protection system 190. The communication module 106 may also be involved in each communication performed by the server 100 system, such as in providing the information services of the service module 102, receiving the payment or payment notification to be verified by the payment verification module 103, and notifying the owner 130 of the payment calculated by the payment issuance module 105, in addition to other communications performed by the server 100 system. The types of communication and communication protocols utilized by the communication module 106 include, but are not limited to, Bluetooth, cellular, and wi-fi.

When a timely payment is not received and verified by the payment verification module 103, the function of the disable unit 1921 to disable the apparatus 180 is not stopped because a valid code is not provided.

In conjunction with disabling the apparatus 180, the location sensor 1933 may provide the location of the apparatus 180, and the location transmitter 1934 may transmit that location to the server 100 system to allow retrieval of the apparatus 180 based on the pre-set terms of the sale.

After disabling of the apparatus 180, if a late payment is permitted and is paid, the payment verification module 103 may verify that not only the payment but also any necessary late-payment fees are paid prior to the code generator module 104 issuing a code to re-enable the apparatus 180.

In another non-limiting embodiment, the owner 130 may lease the apparatus 180 to the lessee 150. In this embodiment, the installation of the payment protection system 190 and integration within the apparatus 180 being leased and the procedure followed based on timely or untimely payments are the same and, thus, are not repeated. Only the additional processes related with this embodiment are discussed.

When the transaction initiated through the server 100 system is a lease, the server 100 computes the tax that must be reported by the owner 130. The service module 102 determines the tax amount based on the payment received from the lessee 150.

In another non-limiting embodiment, the owner 130 may sell the apparatus 180 to the buyer 150 and donate the payments from the buyer 150 to a third party 170. In this embodiment, as well, the installation of the payment protection system 190 and integration within the apparatus 180 being sold and the procedure followed based on timely or untimely payments are the same and, thus, are not repeated. Only the additional processes related with this embodiment are discussed.

The owner 130 may designate the third party 170, such as a charity, to be the recipient of the payments from the buyer 150. In that situation, the payment computed by the payment issuance module 105 is issued to the third party 170 rather than to the owner 130. In addition, when the third party 170 is a qualified charity under the tax code, a tax deduction amount is computed by the service module 102 based on the payment received from the buyer 150. The owner 130 is notified of the deduction amount for a predetermined period, such as a year, by the server 100 system.

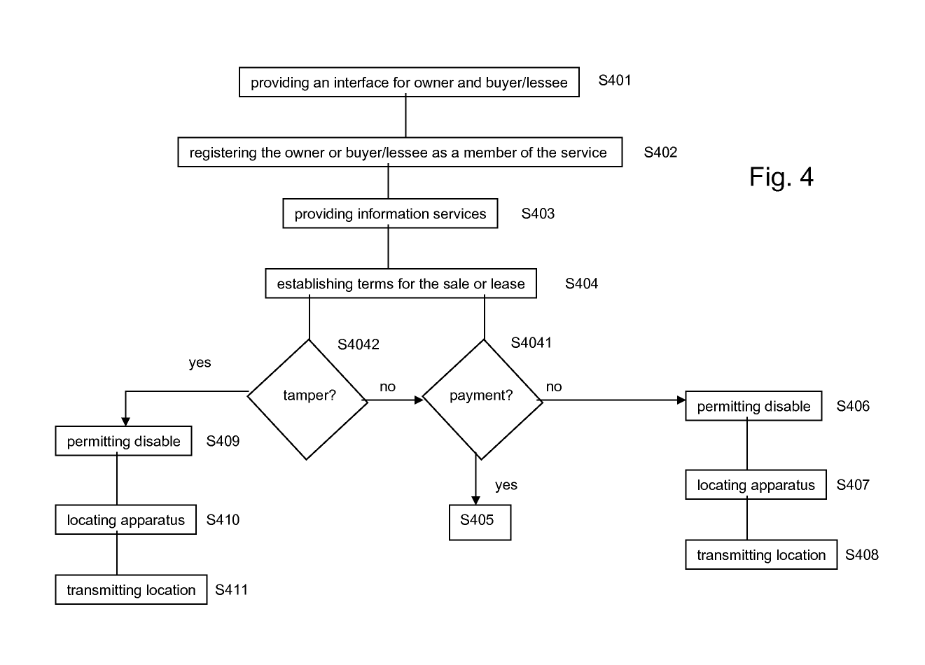

FIG. 4 is a flowchart illustrating steps that may be followed in accordance with an embodiment of a method of practicing the invention. Providing an interface for the owner 130 and buyer or lessee 150 at step S401 includes providing a website or other communication interface for registering as a member at step S402. Providing information services at step S403 includes but is not limited to providing a credit verification and risk evaluation report to the buyer/lessee 150, providing loan services to the owner 130, providing referral services to the owner 130 and/or the buyer/lessee 150, providing insurance verification, providing escrow services, and establishing terms for the sale or lease at step S404.

At step S4041, whether or not a payment was received from the buyer/lessee 150 is determined If a payment was not made by a predetermined date, permitting a disable of the apparatus 180 at step S406 includes withholding a code that would stop the otherwise automatic disabling of the apparatus 180. In addition, locating the apparatus at step S407 includes determining the current location based on the output of a system such as GPS. At step S408, the step of transmitting the location to allow retrieval of the apparatus 180 is performed.

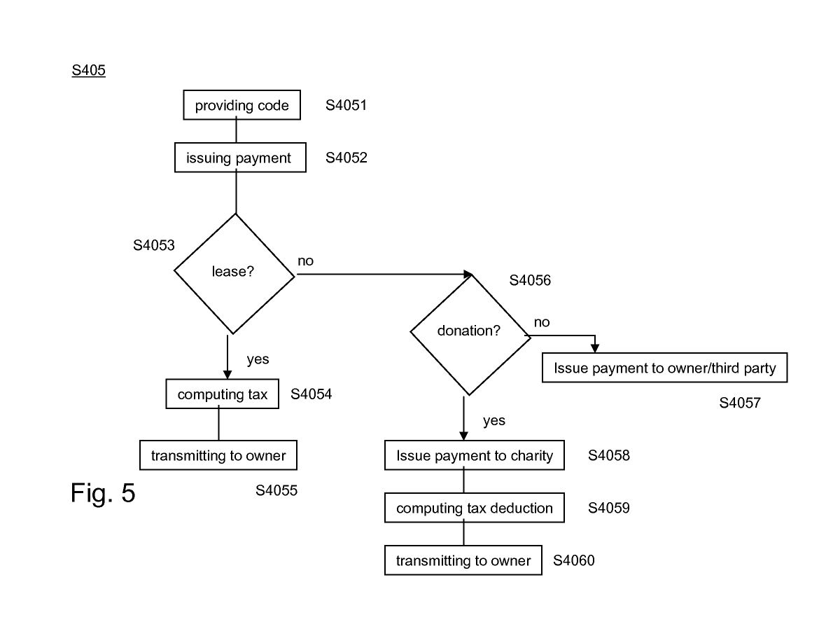

If a payment was made in the correct amount and by the correct date, the method proceeds to step S405, discussed in detail with reference to FIG. 5.

At step S4042, whether or not the payment protection unit 192 was tampered with is determined If the payment protection unit 192 was tampered with, permitting disable at step S409 includes the tamper protection unit 193 disabling the apparatus 180. In addition, locating the apparatus at step S410 includes determining the current location based on the output of a system such as GPS. At step S411, the step of transmitting the location to allow retrieval of the apparatus 180 is performed.

FIG. 5 is a flowchart illustrating the additional steps included in step S405. If a correct payment amount was provided by the correct date, providing the code at S4051 allows the buyer/lessee 150 to enter the code in the code entry unit 191 to stop the disable unit 1921 from disabling the apparatus 180. Providing the code at S4051 may include sending a text message, voice message, email, or other form of communication with the code to the buyer/lessee 150 or sending the code directly to the code entry unit 191 of the payment protection unit 190.

The step of issuing the payment received from the buyer/lessee 150 at S4052 involves determining if the transaction is a purchase or a lease at step S4053 and, if the transaction was a purchase, determining whether the sale was for the benefit of a qualified charity at step S4055.

If, at step S4053, the transaction is determined to be a lease, the proper payment is issued to the owner 130 and, at step S4054, the tax owed by the owner 130 is computed and the owner 130 is notified.

If, at step S4055, the transaction is determined to be a donation or a sale for the benefit of a qualified charity, the payment is made to the charity as the designated third party 170 at step S4057, and a tax deduction is computed at step S4058 and the owner 130 is notified.

Instead, if, at step S4055, the transaction is determined to be a sale without a qualified charity designated as a payee, the payment is issued at step S4056 to the owner 130 or a designated non-charity third party 170, but a tax deduction is not computed.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system of facilitating financing, comprising:
a server including a processor, the server configured to interface with a first user and a second user, the first user financing a transfer of an apparatus to the second user, the server comprising:
a service module to provide services requested by the first user or the second user;
a payment verification module to receive a first payment from the second user;
a payment issuance module to issue a second payment; and
a code generator module configured to generate and transmit a code based on the received first payment; and
a payment protection unit coupled with the apparatus, the payment protection unit comprising:
a disable unit configured to disable an operation of the apparatus at a predetermined time; and
a stop unit configured to stop the disable by the disable unit when the code is received by the payment protection unit.

2. The system of claim 1, wherein the interface with the first user and the second user is a web interface.

3. The system of claim 1, wherein the apparatus is one of a vehicle, a marine equipment, a farm equipment, an office equipment, a building equipment, or a construction equipment.

4. The system of claim 1, wherein the server further comprises a registration module to process a registration of the first user and the second user.

5. The system of claim 1, wherein the services include at least one of credit verification of the second user, risk evaluation of the second user, insurance verification of the second user, escrow service, and referral services.

6. The system of claim 1, wherein the transfer of the apparatus is through a sale.

7. The system of claim 1, wherein the payment issuance module issues the second payment to the first user.

8. The system of claim 1, wherein the payment issuance module issues the second payment to a third party charity designated by the first user in accordance with applicable tax regulations.

9. The system of claim 8, wherein, based on the first payment, the server computes a tax deduction amount and notifies the first user of the tax deduction amount.

10. The system of claim 1, wherein the transfer of the apparatus is through a lease.

11. The system of claim 10, wherein, based on the first payment, the server computes a tax amount and notifies the first user of the tax amount.

12. The system of claim 1, wherein the payment verification module receives the first payment as a communication of a debit card payment by the second user.

13. The system of claim 1, wherein the code generator module transmits the code to the second user for entry into the payment protection unit.

14. The system of claim 13, wherein the code generator module transmits the code to the second user through a text message.

15. The system of claim 1, wherein the code generator module transmits the code directly to the payment protection unit.

16. The system of claim 1 further comprising:
a tamper protection unit comprising:
a tamper sensor;
a location sensor;
a communication unit; and
a location transmitter, wherein
the tamper protection unit is coupled with the apparatus and the payment protection unit and is configured to disable the operation of the apparatus based on the payment protection unit being disabled from full operation.

17. The system of claim 16, wherein the communication unit of the tamper protection unit intermittently receives communication from the payment protection unit, and when the intermittent signal is not received for a predetermined period of time, the tamper sensor determines that tampering has occurred with the payment protection unit.

18. The system of claim 17, wherein when the tamper sensor senses tampering with the payment protection unit, the tamper sensor activates the location sensor to determine a current location of the apparatus, the location transmitter transmits the current location, and the tamper protection unit disables the operation of the apparatus.

19. The system of claim 16, wherein the location sensor is a Global Positioning System (GPS) receiver.

20. A system of facilitating financing, comprising:
a web interface, resulting from processing of software by a processor, presented to a first user who owns an apparatus and to a second user, the web interface providing a registration portion to register the first user and the second user and a transfer portion to negotiate a transfer of the apparatus from the first user to the second user; and
a payment protection unit coupled with the apparatus, the payment protection unit comprising:
a disable unit configured to disable an operation of the apparatus at a predetermined time; and
a stop unit configured to stop the disable by the disable unit when a code is received by the payment protection unit.

21. A method of facilitating financing, comprising the steps of:
providing an interface to a first user and a second user to receive services and to arrange a transfer of an apparatus from the first user to the second user;
verifying a first payment from the second user;
providing a code for entry in a payment protection unit coupled with the apparatus to prevent the payment protection unit from disabling the apparatus, based on verification of the first payment; and
issuing a second payment based on the first payment.

22. The method of claim 21, wherein the services include at least one of credit verification of the second user, risk evaluation of the second user, insurance verification of the second user, escrow service, and referral services.

23. The method of claim 21, wherein the transfer is a sale of the apparatus.

24. The method of claim 21, wherein the issuing the second payment is to the first user.

25. The method of claim 21, wherein the issuing the second payment is to a third party charity designated by the first user in accordance with applicable tax regulations.

26. The method of claim 25 further comprising the steps of:
computing a tax deduction based on the first payment; and
notifying the first user of the tax deduction.

27. The method of claim 21, wherein the transfer is a lease.

28. The method of claim 27 further comprising the steps of:
computing a tax amount based on the first payment; and
notifying the first user of the tax amount.

29. The method of claim 21, wherein the providing the code is via a text message to the second user.

30. The method of claim 21, wherein the providing the code is to the payment protection unit.

31. The method of claim 21 further comprising the steps of:
communicating intermittently from the payment protection unit to a tamper protection unit coupled with the apparatus; and
determining that tampering has occurred with the payment protection unit if the intermittent communication is interrupted for a predetermined period of time.

32. The method of claim 31, wherein when tampering has occurred with the payment protection unit, disabling the apparatus, determining a current location of the apparatus, and transmitting the current location of the apparatus.
